(19) United States
(12) Patent Application Publication
(10) Pub. No.: US 2020/0336982 A1
(43) Pub. Date: Oct. 22, 2020

(54) RELIABLE WUR COMMUNICATIONS

(71) Applicant: QUALCOMM Incorporated, San Diego, CA (US)

(72) Inventors: Alfred ASTERJADHI, San Diego, CA (US); Stephen Jay SHELLHAMMER, Ramona, CA (US); Derrick Chu LIN, Belmont, CA (US)

(21) Appl. No.: 16/848,136

(22) Filed: Apr. 14, 2020

Related U.S. Application Data
(60) Provisional application No. 62/835,645, filed on Apr. 18, 2019.
(60) Provisional application No. 62/843,918, filed on May 6, 2019.

(51) Int. Cl. H04W 52/02

(52) U.S. Cl. CPC H04W 52/0229; H04W 52/0216

(57) ABSTRACT

Methods, systems, and devices for wireless communications are described that enable a keep-alive mode for wakeup radio (WUR) operation. A device may determine whether or not at least one keep-alive frame was received at a WUR during an expected on duration of a duty cycle period associated with the WUR. Another device may generate at least one keep-alive frame. The device may output the at least one keep-alive frame for transmission to a WUR of a second wireless node during an expected on duration of a duty cycle period associated with the WUR of the second wireless node.

### CLAIM OF PRIORITY UNDER 35 U.S.C. § 119

The present application for Patent claims priority to U.S. Provisional Application No. 62/835,645 entitled “RELIABLE WUR COMMUNICATIONS” filed Apr. 18, 2019, and U.S. Provisional Application No. 62/843,918 entitled “RELIABLE WUR COMMUNICATIONS” filed May 6, 2019, assigned to the assignee hereof and hereby expressly incorporated by reference herein.

### BACKGROUND

### Field of the Disclosure

The following relates generally to wireless communications, and more specifically to enabling a keep-alive mode for wake-up radio (WUR) operation.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

As use of wireless networks increases, power constraints of wireless devices may become increasingly critical. Some devices may include a plurality of radios: zero or more “main” radios used for general communications and data transfer on the wireless networks, as well as a secondary or “wake-up” radio for wake-up communications. The wake-up radio may provide for energy efficient communications when the main radio is in a power saving mode. In some cases, the wake-up radio may be the only radio of the device. Improved systems, methods, and devices for communicating over wireless networks with wake-up radios are desired.

### SUMMARY

The systems, methods and devices of this disclosure each have several innovative aspects, no single one of which is solely responsible for the desirable attributes disclosed herein.

An apparatus for wireless communications by a first wireless node that includes a wakeup radio (WUR) is described. The apparatus may include a processing system configured to determine whether or not at least one keep-alive frame was received at the WUR during an expected on duration of a duty cycle period associated with the WUR of the first wireless node.

Another apparatus for wireless communications by a first wireless node is described. The apparatus may include a processing system configured to generate at least one keep-alive frame, and a first interface configured to output the at least one keep-alive frame for transmission to a wakeup radio (WUR) of a second wireless node during an expected on duration of a duty cycle period associated with the WUR of the second wireless node.

A method for wireless communications by a first wireless node that includes a wakeup radio (WUR) is described. The method may include determining whether or not at least one keep-alive frame was received at the WUR during an expected on duration of a duty cycle period associated with the WUR of the first wireless node.

Another method for wireless communications by a first wireless node is described. The method may include generating at least one keep-alive frame, and outputting the at least one keep-alive frame for transmission to a wakeup radio (WUR) of a second wireless node during an expected on duration of a duty cycle period associated with the WUR of the second wireless node.

A wireless node is described. The wireless node may include a wakeup radio (WUR), and a processing system operatively connected to the WUR, the processing system configured to determine whether or not at least one keep-alive frame was received at the WUR during an expected on duration of a duty cycle period associated with the WUR of the wireless node.

A first wireless node is described. The first wireless node may include a processing system configured to generate at least one keep-alive frame, and a transmitter configured to transmit the at least one keep-alive frame to a wakeup radio (WUR) of a second wireless node during an expected on duration of a duty cycle period associated with the WUR of the second wireless node.

An apparatus for wireless communications is described. The apparatus may include means for determining whether or not at least one keep-alive frame was received at a wakeup radio (WUR) during an expected on duration of a duty cycle period associated with the WUR.

Another apparatus for wireless communications is described. The apparatus may include means for generating at least one keep-alive frame, and means for outputting the at least one keep-alive frame for transmission to a wakeup radio (WUR) of a second wireless node during an expected on duration of a duty cycle period associated with the WUR of the second wireless node.

A non-transitory computer-readable storage medium is described. The non-transitory computer-readable storage medium may store instructions that, when executed by one or more processors of a wireless communications device, cause the wireless communications device to determine whether or not at least one keep-alive frame was received at a wakeup radio (WUR) during an expected on duration of a duty cycle period associated with the WUR.

Another non-transitory computer-readable storage medium is described. The non-transitory computer-readable storage medium may store instructions that, when executed by one or more processors of a wireless communications device, cause the wireless communications device to generate at least one keep-alive frame; and output the at least one keep-alive frame for transmission to a wakeup radio (WUR) of a wireless node during an expected on duration of a duty cycle period associated with the WUR of the wireless node.

In some examples of the apparatuses, wireless nodes, methods, and non-transitory computer-readable mediums described herein, determining whether or not the at least one keep-alive frame was received comprises determining an absence of the at least one keep-alive frame received by the WUR during the expected on duration of the duty cycle period associated with the WUR of the first wireless node.

Some examples of the apparatuses, wireless nodes, methods, and non-transitory computer-readable mediums described herein may further include waking up a primary radio of the first wireless node in response to determining the absence of the at least one keep-alive frame.

Some examples of the apparatuses, wireless nodes, methods, and non-transitory computer-readable mediums described herein may further include transmitting a frame from the primary radio of the first wireless node to a second wireless node to verify a connection status between the first wireless node and the second wireless node.

Some examples of the apparatuses, wireless nodes, methods, and non-transitory computer-readable mediums described herein may further include scanning by the primary radio of the first wireless node for a connection with a third wireless node.

Some examples of the apparatuses, wireless nodes, methods, and non-transitory computer-readable mediums described herein may further include enabling a functionality extraneous to the WUR of the first wireless node in response to determining the absence of the at least one keep-alive frame.

In some examples of the apparatuses, wireless nodes, methods, and non-transitory computer-readable mediums described herein, the functionality extraneous to the WUR comprises activation of a switch, activation of an actuator, deactivation of an actuator, or a combination thereof.

In some examples of the apparatuses, wireless nodes, methods, and non-transitory computer-readable mediums described herein, the functionality extraneous to the WUR comprises providing a notification that the first wireless node lost connectivity with a second wireless node.

Some examples of the apparatuses, wireless nodes, methods, and non-transitory computer-readable mediums described herein may further include obtaining the at least one keep-alive frame, and wherein determining whether or not the at least one keep-alive frame was received comprises determining the at least one keep-alive frame was received at the WUR during the expected on duration of a duty cycle period associated with the WUR of the first wireless node.

In some examples of the apparatuses, wireless nodes, methods, and non-transitory computer-readable mediums described herein, the at least one keep-alive frame comprises a WUR beacon frame.

In some examples of the apparatuses, wireless nodes, methods, and non-transitory computer-readable mediums described herein, the WUR beacon frame is individually addressed to the first wireless node.

In some examples of the apparatuses, wireless nodes, methods, and non-transitory computer-readable mediums described herein, the WUR beacon frame is protected, secure, or a combination thereof.

In some examples of the apparatuses, wireless nodes, methods, and non-transitory computer-readable mediums described herein, an ID field of the WUR beacon frame includes a WUR identifier associated with the first wireless node.

In some examples of the apparatuses, wireless nodes, methods, and non-transitory computer-readable mediums described herein, the at least one keep-alive frame comprises a WUR wake-up frame.

In some examples of the apparatuses, wireless nodes, methods, and non-transitory computer-readable mediums described herein, the WUR wake-up frame includes a bit configured to indicate keep-alive functionality of the WUR wake-up frame.

In some examples of the apparatuses, wireless nodes, methods, and non-transitory computer-readable mediums described herein, the bit is further configured to indicate wakeup of a primary radio of the first wireless node.

In some examples of the apparatuses, wireless nodes, methods, and non-transitory computer-readable mediums described herein, the bit is included in a frame control field of the WUR wake-up frame.

In some examples of the apparatuses, wireless nodes, methods, and non-transitory computer-readable mediums described herein, the at least one keep-alive frame comprises a WUR discovery frame or a vendor-specific WUR frame.

Some examples of the apparatuses, wireless nodes, methods, and non-transitory computer-readable mediums described herein may further include generating a first management frame including an indication to request transmission of keep-alive frames from a second wireless node to the first wireless node, and outputting the first management frame for transmission from a primary radio of the first wireless node to the second wireless node.

In some examples of the apparatuses, wireless nodes, methods, and non-transitory computer-readable mediums described herein, the indication comprises a bit in a WUR Mode information element.

Some examples of the apparatuses, wireless nodes, methods, and non-transitory computer-readable mediums described herein may further include obtaining a second management frame from the second wireless node to the primary radio of the first wireless node in response to the transmission of the first management frame, wherein the second management frame includes an indication for confirming or rejecting the request for transmission of keep-alive frames.

Some examples of the apparatuses, wireless nodes, methods, and non-transitory computer-readable mediums described herein may further include obtaining a first management frame from a second wireless node, wherein the first management frame includes an indication to transmit keep-alive frames to the first wireless node.

Some examples of the apparatuses, wireless nodes, methods, and non-transitory computer-readable mediums described herein may further include generating a WUR frame including an indication to request transmission of keep-alive frames from a second wireless node, and outputting the WUR frame for transmission from the WUR of the first wireless node to the second wireless node.

Some examples of the apparatuses, wireless nodes, methods, and non-transitory computer-readable mediums described herein may further include generating keep-alive frames for each expected on duration associated with the WUR of the second wireless node, and outputting the keep-alive frames for transmission during each expected on duration associated with the WUR of the second wireless node.

Some examples of the apparatuses, wireless nodes, methods, and non-transitory computer-readable mediums described herein may further include outputting the at least one keep-alive frame to a WUR of a third wireless node during an expected on duration of a duty cycle period associated with the WUR of the third wireless node.

In some examples of the apparatuses, wireless nodes, methods, and non-transitory computer-readable mediums described herein, the at least one keep-alive frame includes an individual address, a group address, or a broadcast address.

Some examples of the apparatuses, wireless nodes, methods, and non-transitory computer-readable mediums described herein may further include obtaining an indication to generate keep-alive frames for the second wireless node.

In some examples of the apparatuses, wireless nodes, methods, and non-transitory computer-readable mediums described herein, the at least one keep-alive frame is generated in response to the obtained indication.

Some examples of the apparatuses, wireless nodes, methods, and non-transitory computer-readable mediums described herein may further include generating a first frame including an indication to utilize keep-alive frames in a WUR mode, and outputting the first frame for transmission to the second wireless node.

In some examples of the apparatuses, wireless nodes, methods, and non-transitory computer-readable mediums described herein, the first frame comprises a management frame for transmission to a primary radio of the second wireless node or a WUR frame for transmission to the WUR of the second wireless node.

In some examples of the apparatuses, wireless nodes, methods, and non-transitory computer-readable mediums described herein, the indication is obtained from a user interface operatively connected to the first wireless node.

In some examples of the apparatuses, wireless nodes, methods, and non-transitory computer-readable mediums described herein, the indication is obtained from a first frame received from the second wireless node, the first frame including an indication to request transmission of keep-alive frames.

In some examples of the apparatuses, wireless nodes, methods, and non-transitory computer-readable mediums described herein, the first frame comprises a management frame received from a primary radio of the second wireless node or a WUR frame received from the WUR of the second wireless node.

In some examples of the apparatuses, wireless nodes, methods, and non-transitory computer-readable mediums described herein, the first frame comprises the management frame, and wherein the indication comprises a bit in a WUR Mode information element.

Some examples of the apparatuses, wireless nodes, methods, and non-transitory computer-readable mediums described herein may further include generating a management frame in response to the first frame, wherein the management frame includes an indication for confirming or rejecting the request for transmission of keep-alive frames, and outputting the management frame for transmission to the second wireless node.

Some examples of the apparatuses, wireless nodes, methods, and non-transitory computer-readable mediums described herein may further include a second interface configured to obtain a frame from a primary radio of the second wireless node, the frame indicating an absence of keep-alive frames received by the WUR of the second wireless node during the expected on duration of the duty cycle period associated with the WUR of the second wireless node.

### BRIEF DESCRIPTION OF THE DRAWINGS

FIG. 1 illustrates an example of a system for wireless communications that supports utilization of keep-alive frames in WUR communications in accordance with aspects of the present disclosure.

FIG. 2 illustrates an example of various components that may be utilized in a wireless node that supports utilization of keep-alive frames in WUR communications in accordance with aspects of the present disclosure.

FIG. 3 illustrates an example of a process flow that supports utilization of keep-alive frames in WUR communications in accordance with aspects of the present disclosure.

FIG. 4 illustrates an example of WUR duty cycle operation in accordance with aspects of the present disclosure.

FIG. 5 illustrates an example WUR frame in accordance with aspects of the present disclosure.

FIG. 6 illustrates an example of a process flow that supports utilization of keep-alive frames in WUR communications in accordance with aspects of the present disclosure.

FIG. 7 illustrates a flowchart of an example method that supports utilization of keep-alive frames in WUR communication in accordance with aspects of the present disclosure.

FIG. 8 illustrates a flowchart of an example method that supports utilization of keep-alive frames in WUR communication in accordance with aspects of the present disclosure.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The described features generally relate to enabling a keep-alive mode for wake-up radio (WUR) operation. An access point (AP) may send keep-alive frames to a WUR of a station (STA) at a start or during every expected on duration of a duty cycle period associated with the WUR. An absence of a keep-alive frame at the WUR during the expected on duration of the duty cycle period may cause the STA to take action. The WUR keep-alive mode may provide keep-alive functionality for a STA to determine whether it is still connected to the AP. When a keep-alive frame is not received by the STA, a primary radio may wake up and transmit a frame to the AP to check a connection status. A connection drop can then be reported to a user via a user interface of the STA and/or the STA can scan for another AP. In so doing, the WUR keep-alive mode may allow a reliable connection between the STA and a network by facilitating roaming between APs.

The WUR keep-alive mode may also provide a low latency, time-sensitive connection in applications related to the consumer internet-of-things (IoT), such as home automation, and/or the industrial internet-of-things (IIoT). In one example for an IIoT application, the keep-alive frames may be useful when the WUR is deployed as a safety mechanism to send emergency signals, such as to stop machine operation. For instance, when a keep-alive frame is not received by the WUR during the expected on duration of the duty cycle period, the WUR can activate or deactivate one or more switches and actuators to stop the machine from continuing operation. In so doing, the WUR can provide functionalities while still in a low power mode without utilizing a primary radio.

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented, or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols. The various aspects described herein may also apply to any cellular communication standard or protocol.

In some implementations, a WLAN includes various devices which are the components that access the wireless network. For example, there may be two types of devices: access points (“APs”) and clients (also referred to as stations, or “STAs”). In general, an AP serves as a hub or base station for the WLAN and a station (STA) serves as a user of the WLAN. For example, a STA may be a laptop computer, a personal digital assistant (PDA), a mobile phone, a watch, etc. In an example, a STA connects to an AP via a WiFi (e.g., IEEE 802.11 protocol) compliant wireless link to obtain general connectivity to the Internet or to other wide area networks. In some implementations a STA may also be used as an AP.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. A TDMA system may implement GSM or some other standards known in the art. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An OFDM system may implement IEEE 802.11 or some other standards known in the art. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. A SC-FDMA system may implement 3GPP-LTE (3rd Generation Partnership Project Long Term Evolution) or other standards.

The teachings herein may be incorporated into (e.g., implemented within or performed by) a variety of wired or wireless apparatuses (e.g., nodes). In some aspects, a wireless node implemented in accordance with the teachings herein may comprise an access point (“AP”) or a station (“STA”).

An AP may comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A STA may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, a wake-up radio, an IIoT application, or any other suitable device that is configured to communicate via a wireless medium.

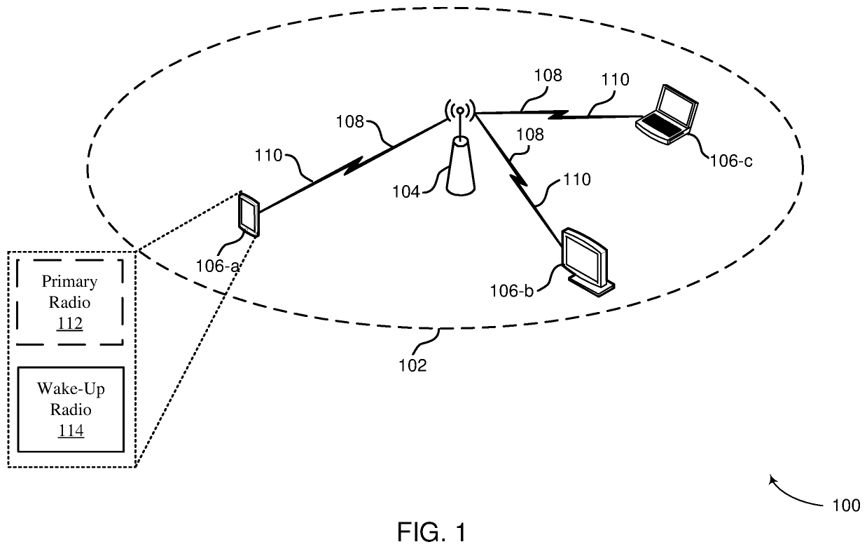

FIG. 1 is a diagram of an exemplary wireless communication system 100 in which aspects of the present disclosure may be employed. The wireless communication system 100 may operate pursuant to a wireless standard, for example a high throughput (HT) 802.11 standard, a very high throughput (VHT) 802.11 standard, a high-efficiency (HE) 802.11 standard, an extreme high throughput (EHT) 802.11 standard, or any other wireless communication standard. The wireless communication system 100 may include an AP 104, which communicates with STAs 106 (referring generally to the STAs 106A-106C).

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with code division multiple access (CDMA) techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel. This communication link may be established via a single-input-single-output (SISO), multiple-input-single-output (MISO), single-input-multiple-output (SIMO), or a multiple-input-multiple output (MIMO) system.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network (for example TDLS, WiFi-Direct) between the STAs 106. Accordingly, the functions of the AP 104 described herein may alternatively be performed by one or more of the STAs 106.

In some aspects, a STA 106 may be required to associate with the AP 104 in order to send communications to and/or receive communications from the AP 104. In one aspect, information for associating is included in a broadcast by the AP 104. To receive such a broadcast, the STA 106 may, for example, perform a broad coverage search over a coverage region. A search may also be performed by the STA 106 by sweeping a coverage region in a lighthouse fashion, for example. After receiving the information for associating, the STA 106 may transmit a reference signal, such as an association probe or request, to the AP 104. In some aspects, the AP 104 may use backhaul services, for example, to communicate with a larger network, such as the Internet or a public switched telephone network (PSTN). In some aspects, the STA 106 may already be associated with AP 104 and may periodically monitor the communications from the AP 104 for communications directed to the STA 106.

In some implementations, one or more of the STAs 106 of the BSA 102 may include one or more radios 112, 114. For example, the STAs 106 may include a primary radio 112 that is used to perform communications within wireless communication system 100 and a low power radio or wake-up radio (WUR) 114 that is used to monitor for wake-up or similar low power communications from the AP 104 when the STA 106 is in a low power or power saving mode. In some implementations, the STAs 106 may only include the WUR 114. In some implementations the STA may include more than one primary radio 112, each of which may operate in different bands (e.g., sub-1 GHz, 2.4, 5, 6, 18, 60 GHz etc.) or with different wireless technologies (LTE, Bluetooth, 802.11). The STAs 106 including the WUR 114 may be designated as WUR STAs.

The WUR 114 may be a transmitter and/or receiver circuit with minimal capabilities (e.g., minimal compatibility with communication frequencies and speeds) for communication over the communication system 100. In some implementations, the WUR 114 may include fewer features than the primary radio, for example lack of advanced encoder/decoder capabilities, etc. Accordingly, the WUR 114 may be lower in cost than the primary radio 112 and may also consume less power than the primary radio 112 when in operation. Thus, the WUR 114 may be used to monitor for communications to the STA 106 more efficiently than using the primary radio 112 of the STA 106. In certain cases, the WUR 114 may be operating in a different channel/band compared to the one or more primary radios 112. The WUR 114 may be configured to receive instructions from the AP 104 (or other devices broadcasting on the wireless communication system 100). These instructions may include instructions to wake up the primary radio and/or perform other actions that do not require activation of the primary radio.

In some examples, the AP 104 and/or the STAs 106 may be configured to generate various WUR communications for WUR devices. For example, the AP 104 and/or the STAs 106 may be configured to synchronize devices based on a WUR Beacon transmission. Additionally, or alternatively, the AP 104 and/or the STAs 106 may transmit unicast WUR messages to wake up a single WUR STA or multicast/broadcast WUR messages to wake up multiple or all WUR STAs. The AP 104 and/or the STAs 106 may be configured to generate and transmit WUR Beacon frames/messages, WUR control frames/messages, etc. Similarly, the WUR STAs may be configured to perform various operations based on the received WUR communications. For example, the WUR STAs may synchronize based on WUR Beacon reception that includes timing information, may wake up based on an individual or multicast/broadcast wakeup message, may activate lights or perform actions, etc.

WUR communications may be generally based on typical IEEE 802.11 communication structures, e.g., according to IEEE 802.11ba. For example, communication frames may include preambles, addressing information, control information, and frame check information. However, the IEEE 802.11 communication structures may be customized for WUR communication (e.g., WUR PPDUs) in order to reduce and/or minimize overhead and maintain signaling of essential information to enable various operations, as in IEEE 802.11ba. In some implementations, the WUR PPDUs may provide flexibility for a wide range of use cases and scenarios.

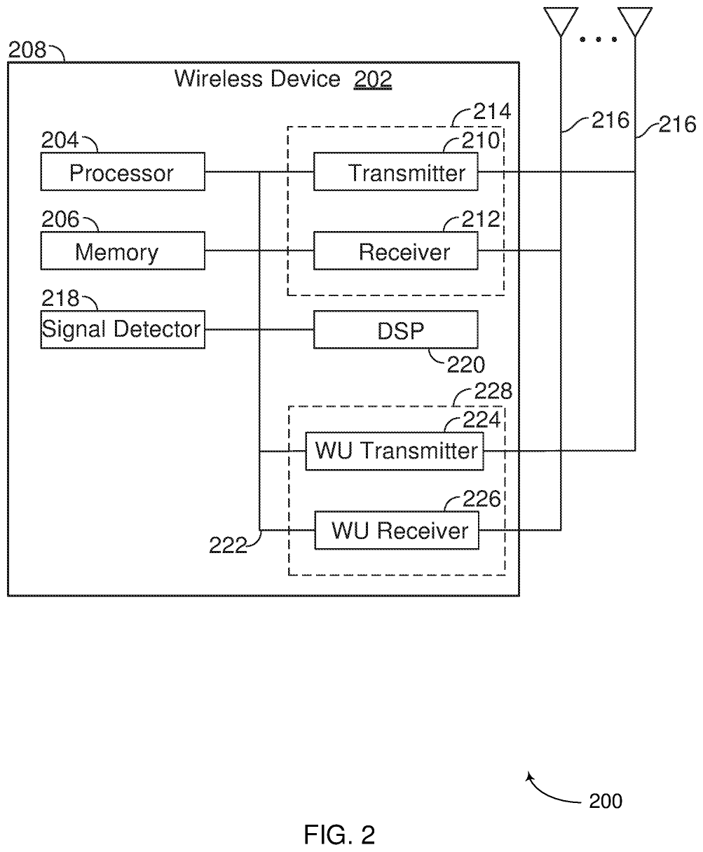

FIG. 2 illustrates an example of various components that may be utilized in a wireless node 200, or a wireless device 202, that supports utilization of keep-alive frames in WUR communications in accordance with aspects of the present disclosure. In some examples, the wireless device 202 may implement aspects of wireless communication system 100. The wireless device 202 is an example of a device that may be configured to implement the various methods described herein. The wireless device 202 may implement a WUR AP or a WUR STA. In some implementations, the wireless device 202 may implement an AP 104 or a STA 106.

The wireless device 202 may include a processor 204 which controls operation of the wireless device 202. The processor 204 may also be referred to as a central processing unit (CPU). Memory 206, which may include both read-only memory (ROM) and random-access memory (RAM), provides instructions and data to the processor 204. A portion of the memory 206 may also include non-volatile random-access memory (NVRAM). The processor 204 may perform logical and arithmetic operations based on program instructions stored within the memory 206. The instructions in the memory 206 may be executable to implement the methods described herein.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location and/or device. The transmitter 210 and receiver 212 may be combined into a transceiver 214. A single or a plurality of transceiver antennas 216 may be attached to the housing 208 and electrically coupled to the transceiver 214. The wireless device 202 may also include multiple transmitters (e.g., WUR transmitter 224), multiple receivers (e.g., WUR receiver 226), and multiple transceivers (e.g., WUR transceiver 228). In some cases, the wireless device 202 may only include the WUR transmitter 224 and the WUR receiver 226, or WUR transceiver 228, and may not include any other transmitters (e.g., transmitter 210), receivers (e.g., receiver 212), or transceivers (e.g., transceiver 214).

The wireless device 202 may also include a signal detector 218 that may be used in an effort to detect and quantify the level of signals received by the transceiver 214 or the transceiver 228. The signal detector 218 may detect such signals as total energy, energy per subcarrier per symbol, power spectral density and other signals. The wireless device 202 may also include a digital signal processor (DSP) 220 for use in processing signals. In some aspects, the wireless device may also include one or more of a user interface component (not shown) and a wireless LAN (WLAN) modem (not shown). The WLAN modem may provide for communications using one or more WiFi technologies, such as any of the IEEE 802.11 protocol standards.

The various components of the wireless device 202 may be coupled together by a bus system 222, which may include a bus interface, a power bus, a control signal bus, and a status signal bus in addition to a data bus.

Certain aspects of the present disclosure support transmitting an uplink (UL) signal or a downlink (DL) signal between one or more STAs, WUR STAs, APs, and WUR APs. In some examples, the signals may be transmitted in a multi-user MIMO (MU-MIMO) system. Alternatively, the signals may be transmitted in a multi-user FDMA (MU-FDMA) or similar FDMA system. In some aspects, these signals may be transmitted using one or more of the transmitter 210 and the WUR transmitter 224.

In some examples, the WUR transmitter 224, the WUR receiver 226, and/or the WUR transceiver 228 may be configured to communicate with limited or minimal power consumption. Accordingly, the WUR transmitter 224, the WUR receiver 226, and/or the WUR transceiver 228 may be limited to operation at specific frequencies and/or bandwidths. For example, the WUR transmitter 224, the WUR receiver 226, and/or the WUR transceiver 228 may be configured to operation at one of 915 MHz, 2.4 GHz, and/or 5.0 GHz, 6 GHz, 18 GHz and/or 60 GHz frequency bands at speeds of 62.5 Kbps and/or 250 Kbps, although not limited to these frequencies or speeds. In some implementations, the WUR devices may be limited to operation in heavy utilized the industrial, scientific, and medical (ISM) radio bands. Based on such speeds and limitations transmitting even a limited number of bytes would require significant amount of time, as an example transmitting seven (7) bytes of information may utilize ˜1 ms transmission time assuming a speed of 62.5 kbps.

Furthermore, the WUR devices (e.g., WUR APs and WUR STAs) may be configured such that the corresponding radio systems operate in one of four states at any given time. For example, in a first state, both the WUR transceiver 228 and the transceiver 214 are off. In a second state, the WUR transceiver 228 is on while the transceiver 214 is off. In a third state, the WUR transceiver 228 is off while the transceiver 214 is on. In a fourth state both are on. And the number of states may increase proportionally with the number of primary radios which may be greater than one. The WUR transmitter 224, the WUR receiver 226, and/or the WUR transceiver 228 and the transmitter 210, the receiver 212, and the transceiver 214 may share the same one or more antennas 216 and may operate in the same band or may operate in separate bands. Accordingly, the corresponding WUR components and primary radio components may be configured to operate only one at a time so that only WUR communications or primary radio communications are being transmitted/received at any given moment. In some examples, when the device 202 includes multiple antennas 216 coupled to the WUR transmitter 224, the WUR receiver 226, and/or the WUR transceiver 228 and the transmitter 210, the receiver 212, and the transceiver 214, the processor 204 may be configured to dedicate one or more antennas 216 to the WUR transmitter 224, the WUR receiver 226, and/or the WUR transceiver 228 and one or more of the remaining 216 antennas to the transmitter 210, the receiver 212, and the transceiver 214 to allow simultaneous WUR and main channel communications. The STA may also turn off the WUR radio and allocate all antennas to the main radio.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements. Additionally, additional components not illustrated in FIG. 2 may be included in any of the devices 202. Those of skill in the art will also recognize that one or more components illustrated in FIG. 2 may not be included in any of the devices 202.

The wireless device 202 may comprise an AP 104 and/or a STA 106, and may be used to transmit and/or receive communications. That is, either AP 104 or STA 106 may serve as transmitter or receiver devices. Certain aspects contemplate signal detector 218 being used by software running on memory 206 and processor 204 to detect the presence of a transmitter or receiver.

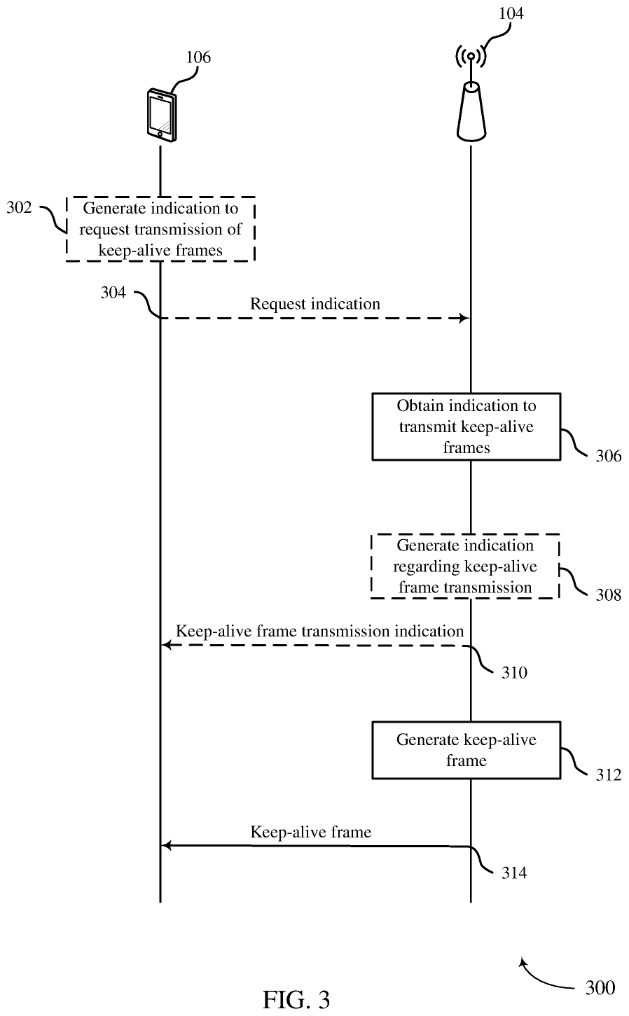

FIG. 3 illustrates an example of a process flow 300 that supports utilization of keep-alive frames in WUR communications in accordance with various aspects of the present disclosure. Process flow 300 may include STA 106 and AP 104, which may be examples of the corresponding devices described with reference to FIG. 1. STA 106 may include the WUR 114.

The utilization of keep-alive frames to the WUR 114 may provide reliable, low-latency WUR communications compared to current state-of-the-art WUR communications. For example, if an AP sends a WUR wake-up frame to the WUR during an expected on duration in order to wake up a primary radio of the STA, and the STA does not receive the WUR wake-up frame, then the STA remains as is, and the AP has to send another WUR wake-up frame at a later time. The STA does not take action if it does not receive the WUR wake-up frame from the AP. When the STA finally receives a WUR wake-up frame, it turns on the primary radio and transmits a frame (e.g., PS-Poll, QoS Null, or QoS Data) from the primary radio to the AP, which requires an acknowledgement from the AP. This may result in prolonged latency for verifying a connection status, discovering lost connectivity, and/or re-establishing a connection to a network. When the STA and the AP move out of range from each other and lose connectivity, this may adversely affect WUR operation. As such, reliable, low-latency WUR communications are desirable.

According to some aspects, by providing the transmission of keep-alive frames, the STA 106 can continue standard operation if it receives at least one keep-alive frame during the expected on duration of a duty cycle associated with the WUR 114 of the STA 106. Moreover, in an absence of a reception of a keep-alive frame during the expected on duration, the STA 106 may wake up the primary radio 112 and/or perform other actions. Whether there is reception or there is the absence of the reception of at least one keep-alive frame, the STA 106 may proactively verify the connection status, discover lost connectivity, and/or re-establish the connection to the network. The STA 106 may also initiate other actions unrelated to or extraneous to the WUR 114 and/or the primary radio 112 in the absence of the reception of a keep-alive frame, which may be useful when roaming or in an Industrial Internet of Things (IIoT) setting with latency sensitive operations that require networked automation of heavy manufacturing equipment or machinery. As such, the transmission of keep-alive frames from the AP 104 provides reliable connectivity, as well as a low-latency, time-sensitive reaction from the STA 106 in the absence of the reception of a keep-alive frame.

At step 302, the STA 106 may optionally generate an indication to request transmission of keep-alive frames from the AP 104 to the STA 106. According to some aspects, the indication may comprise a bit. For instance, the STA may set the bit to “1” to indicate a use of keep-alive frames is requested and may set the bit to “0” to indicate the use of keep-alive frames is not requested. In some aspects, the bit may comprise a keep-alive bit. According to some aspects, the STA 106 may generate a frame that includes the indication to request transmission of keep-alive frames from the AP 104 to the STA 106. In some aspects, the frame may comprise a management frame, such as a WUR Mode Setup frame, and the indication may be included in a WUR Mode information element. In some aspects, the frame may be transmitted to the AP 104 via the primary radio. In some aspects, the frame may comprise a WUR frame. Other configurations for the indication to request transmission of keep-alive frames may be used. For example, the AP 104 may be configured by default to generate keep alive frames to STAs that are in WUR mode.

At step 304, the STA 106 may optionally indicate to the AP 104 the request for transmission of keep-alive frames from the AP 104 to the STA 106. In some aspects, the STA 106 may transmit, to the AP 104, the indication to request transmission of keep-alive frames. In some aspects, the STA 106 may transmit to the AP 104 the management frame, such as the WUR Mode Setup frame, including the indication to request keep-alive frames during a WUR mode setup. For instance, the STA 106 may transmit the management frame, such as the WUR Mode Setup frame, from the primary radio 112 of the STA 106 to the AP 104, while the STA 106 is not in a WUR mode. In some aspects, the STA 106 may transmit to the AP 104 the WUR frame including the indication to request keep-alive frames during the WUR mode. For example, the STA 106 may transmit the WUR frame from the WUR 114 of the STA 106 while in the WUR mode.

At step 306, the AP 104 may obtain an indication to transmit keep-alive frames. According to some aspects, the indication may be obtained from a frame transmitted by the STA 106, such as the management frame or the WUR Mode Setup frame received from the primary radio 112 of the STA 106 or the WUR frame received from the WUR 114 of the STA 106. For example, the AP 104 may receive the indication to request transmission of keep-alive frames from the STA 106. The indication may comprise the bit, such as the keep-alive bit in the WUR Mode information element. In some aspects, the AP may not obtain the indication from a frame transmitted by the STA 106 and may obtain the indication via other configurations. For instance, the AP 104 may obtain the indication from a user interface operatively connected to a processing system of the AP 104. The AP 104 may be configured to transmit keep-alive frames to the STA 106 based on user input into the user interface of the AP 104, such as via a push-button, touch screen, or other operator control. The indication to transmit keep-alive frames may be obtained by the AP 104 in other ways as well.

At step 308, the AP 104 may optionally generate an indication regarding keep-alive frame transmission. According to some aspects, the indication may comprise a bit. For instance, the AP 104 may set the bit to “1” to indicate keep-alive frames will be transmitted from the AP 104 to the STA 106 and may set the bit to “0” to indicate keep-alive frames will not be transmitted from the AP 104 to the STA 106. In some aspects, the bit may comprise a keep-alive bit. According to some aspects, the AP 104 may generate a frame that includes the indication regarding keep-alive frame transmission from the AP 104. In some aspects, the frame may comprise a management frame, such as a WUR Mode Setup frame, and the indication may be included in a WUR Mode information element. In some aspects, the frame may comprise a WUR frame.

According to some aspects, the AP 104 may generate the indication, at step 308, in response to obtaining the indication to transmit keep-alive frames, at step 306. In some aspects, the AP 104 may generate the indication in response to the request by the STA 106 for transmission of keep-alive frames. For example, the indication may confirm or reject the request by the STA 106 for transmission of keep-alive frames. In some aspects, the indication generated by the AP 104 may be unsolicited. In some aspects, the AP 104 may generate the indication in response to the indication obtained from the user interface. Other configurations for the indication regarding keep-alive frame transmission may be used.

At step 310, the AP 104 may optionally provide to the STA 106 the indication regarding keep-alive frame transmission. In some aspects, the AP 104 may transmit, to the STA 106, the indication regarding keep-alive frame transmission. In some aspects, the AP 104 may transmit to the STA 106 the management frame, such as the WUR Mode Setup frame, including the indication regarding keep-alive frame transmission during a WUR mode setup. For instance, the AP 104 may transmit the management frame, such as the WUR Mode Setup frame, to the primary radio of the STA 106, while the STA 106 is not in a WUR mode. In some aspects, the AP 104 may transmit to the STA 106 the WUR frame including the indication to request keep-alive frames during the WUR mode. For example, the AP 104 may transmit the WUR frame to the WUR 114 of the STA 106 while the STA 106 is in the WUR mode. In some aspects, the AP 104 may transmit the indication regarding keep-alive frame transmission to the STA 106 either in response to a management frame received by the STA 106 or unsolicited.

At step 312, the AP 104 may generate at least one keep-alive frame. In some aspects, the AP 104 may generate the at least one keep-alive frame after or in response to obtaining the indication to transmit keep-alive frames, at step 306. In some aspects, the AP 104 may be configured to generate at least one keep-alive frame for each expected on duration associated with the WUR 114 of the STA 106.

At step 314, the AP 104 may transmit the at least one keep-alive frame to the STA 106 while the STA 106 is in the WUR mode. In some aspects, the AP 104 may transmit the at least one keep-alive frame to the WUR 114 of the STA 106 during an expected on duration of a duty cycle period associated with the WUR 114 of the STA 106. In some aspects, the AP 104 may be configured to transmit at least one keep-alive frame during each expected on duration associated with the WUR 114 of the STA 106.

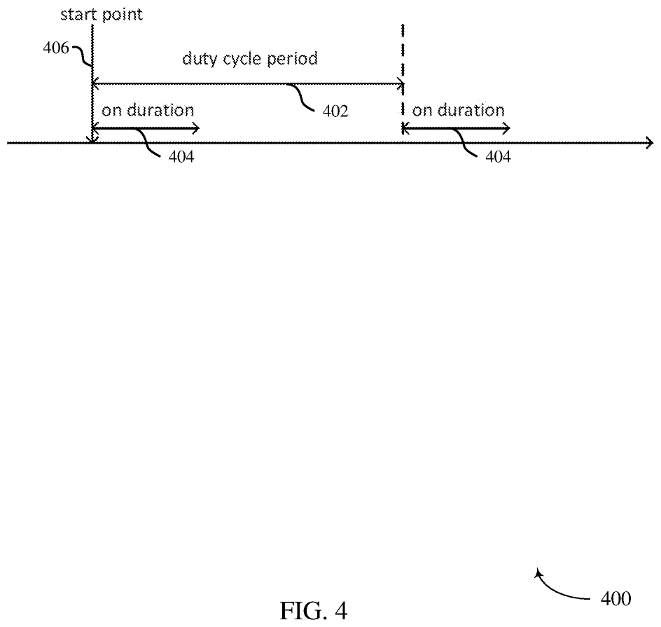

FIG. 4 illustrates WUR duty cycle operation 400 of the WUR 114 of the STA 106, in accordance with various aspects of the present disclosure. In the WUR mode, the WUR 114 of the STA 106 may cycle through a WUR awake state and a WUR doze state. This may be referred to as WUR duty cycle operation 400. The WUR duty cycle operation 400 may reduce an amount of time that the WUR 114 of the STA 106 needs to be awake or powered on. The WUR duty cycle operation 400 may be determined by a duty cycle period 402, an on duration 404, and a start point 406. The duty cycle period 402 may comprise a duration it takes the WUR 114 to complete one on-and-off cycle, or to cycle through one WUR awake state and one WUR doze state. The on duration 404 may comprise a duration for which the WUR 114 is awake or powered on. The start point 406 may comprise a start time of the on duration 404. The start time of a subsequent on duration may be equal to the start point 406 plus the duty cycle period 402, and so forth. The AP 104 and the STA 106 may negotiate the duty cycle period 402, the on duration 404, and the start point 406, such as during WUR mode setup.

According to some aspects, the AP 104 is configured to transmit one or more keep-alive frames during each expected on duration 404 of the duty cycle period 402 associated with the WUR 114 of the STA 106. In some aspects, the AP 104 may transmit the one or more keep-alive frames to the WUR 114 of the STA 106 at a beginning of every on duration 404, although the AP 104 may transmit the one or more keep-alive frames at any time during the on duration 404. In some aspects, the AP 104 may be configured to transmit one or more keep-alive frames to a plurality of STAs 106 during each expected on duration 404 of the duty cycle period 402 associated with a WUR of each STA 106. In some aspects, the one or more keep-alive frames may include an individual address, a group address, or a broadcast address.

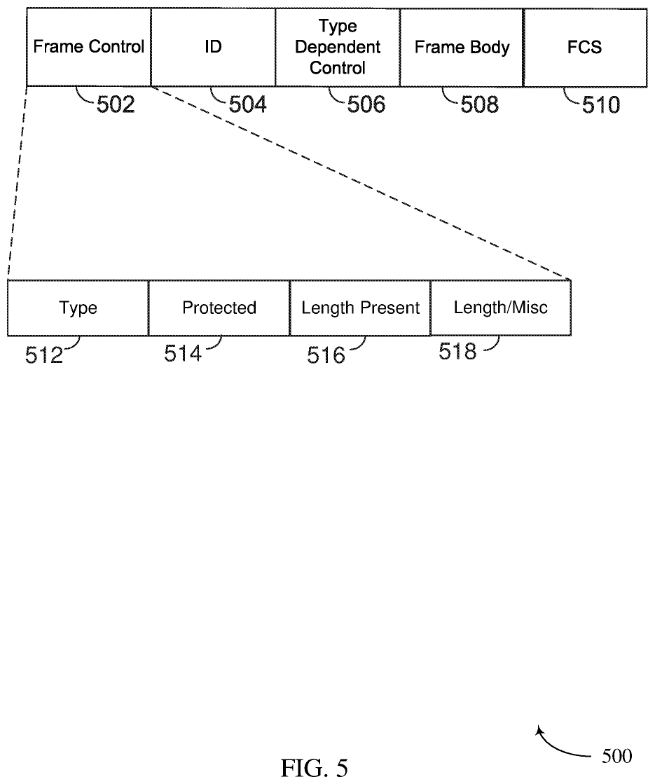

FIG. 5 illustrates an example WUR frame 500 in accordance with aspects of the present disclosure. The WUR frame 500 may include a frame control field 502, an ID field 504, a type dependent control field 506, a frame body field 508, and a frame check sequence (FCS) field 510. The frame control field 502 may provide information that identifies details of a frame type, a frame length, and/or other information. The ID field 504 may provide an identifier for the WUR frame 500, and the identifier may depend on the frame type. Example identifiers for the WUR frame 500 in the ID field 504 are provided below in Table 1:

TABLE 1
Identifiers of WUR frames

| ID field | Identifier description |
|---|---|
| Transmitter ID | Identifier of the transmitting AP (may be provided by |
| | the AP to the WUR STAs) |
| Nontransmitter ID | Identifier of the nontransmitted BSSID (may be |
| | provided by the AP to all the WUR STAs associated |
| | with the nontransmitted BSSID) |
| WUR Group ID | Identifier of a group of receiving WUR non-AP STAs |
| | (may be provided by the AP to the group of WUR non- |
| | AP STAs) |
| WUR ID | Identifier of an individual receiving WUR non-AP |
| | STA (may be provided by the AP to the WUR non-AP |
| | STA) |
| OUI1 | The 12 LSBs of the OUI (see 9.4.1.31 (Organization |
| | Identifier field)) |

The type dependent control field 506 may provide control information that depends on the frame type. The frame body field 508 may comprise a payload of the WUR frame 500 and may be of variable length. A content of the frame body field 508 may be dependent on the frame type and/or other settings in the fields that precede it in the WUR frame 500. The frame body field 508 may provide information specific to individual WUR frame types. The frame body field 508 may not be present in a constant length WUR frame and may be present in a variable-length WUR frame. The FCS field 510 may include a cyclic redundancy check (CRC) if the WUR frame 500 is not secure or a message integrity check (MIC) if the WUR frame 500 is secure.

The frame control field 502 may include a type subfield 512, a protected subfield 514, a length present subfield 516, and a length/miscellaneous subfield 518. The type subfield 512 may indicate a type of the WUR frame 500, such as provided below in Table 2:

TABLE 2
WUR frame types

| Type | Type description |
|---|---|
| 0 | WUR Beacon |
| 1 | WUR Wake-Up |
| 2 | WUR Vendor Specific |
| 3 | WUR Discovery |
| 4-7 (if 3 bits) | Reserved |
| or 4-15 (if 4 | |
| bits) | |

For example, when the type subfield 512 includes a value of “0”, the WUR frame 500 may be a WUR beacon frame. When the type subfield 512 includes a value of “1”, the WUR frame 500 may be a WUR wake-up frame. When the type subfield 512 includes a value of “2”, the WUR frame 500 may be a WUR vendor specific frame. When the type subfield 512 includes a value of “3”, the WUR frame 500 may be a WUR discovery frame. When the type subfield 512 includes a value of “4” or greater, the WUR frame 500 may be another specific type of frame.

The protected subfield 514 of the frame control field 502 may indicate whether information carried in the WUR frame 500 has been processed by a MIC algorithm. If the protected subfield 514 is set to “1”, the WUR frame 500 may be protected utilizing the MIC algorithm. If the protected subfield 514 is set to “0”, the WUR frame 500 may contain the CRC.

The length present subfield 516 may indicate whether the length/miscellaneous subfield 518 contains a length subfield or not. If the length present subfield is set to “1”, the length/miscellaneous subfield 518 may contain the length subfield. If the length present subfield is set to “0”, the length/miscellaneous subfield 518 may contain a miscellaneous subfield. When the length/miscellaneous subfield 518 is operating as the length field, such as in the variable length WUR frame, the length field may contain a length of the frame body field 508 or the payload. When the length/miscellaneous subfield 518 is operating as the miscellaneous subfield, such as in the constant length WUR frame, the miscellaneous subfield may contain bits that are expected to be used to indicate or convey various other information. Other configurations for the WUR frame 500 may be used.

According to some aspects, the one or more keep-alive frames may comprise a WUR beacon frame. In some aspects, the WUR beacon frame may be individually addressed to the STA 106. In some aspects, the ID field (e.g., the ID field 504) of the WUR beacon frame may include a WUR identifier (e.g., one of the identifiers for the WUR frame 500 in Table 1) that is associated with the STA 106. In some aspects, the WUR beacon frame may be protected, secure, or a combination thereof. For example, the WUR beacon frame may be encrypted and/or may include the CRC or the MIC. Other configurations for utilizing the WUR beacon frame as the one or more keep-alive frames may be used.

According to some aspects, the one or more keep-alive frames may comprise a WUR wake-up frame. In some aspects, the WUR wake-up frame may include a bit configured to indicate keep-alive functionality of the WUR wake-up frame. The bit may be further configured to indicate wakeup of the primary radio 112 of the STA 106. For instance, the AP 104 may set the bit to “0” to indicate the WUR wake-up frame is a keep-alive frame and may set the bit to “1” to indicate the primary radio 112 should wake up (or vice-versa). In some aspects, the bit may be included in a frame control field (e.g., the frame control field 502) of the WUR wake-up frame. Other configurations for utilizing the WUR wake-up frame as the one or more keep-alive frames may be used.

In some aspects, the one or more keep-alive frames may comprise a WUR discovery frame. In some aspects, the one or more keep-alive frames may comprise a vendor-specific WUR frame. In some aspects, the one or more keep-alive frames may comprise various combinations of a WUR beacon frame, a WUR wake-up frame, a WUR discovery frame, and/or a vendor-specific WUR frame. In some aspects, the one or more keep-alive frames may comprise a new frame type, such as a keep-alive frame, to be defined by the IEEE 802.11ba or other standard. Other configurations for the one or more keep-alive frames in the WUR mode may be used.

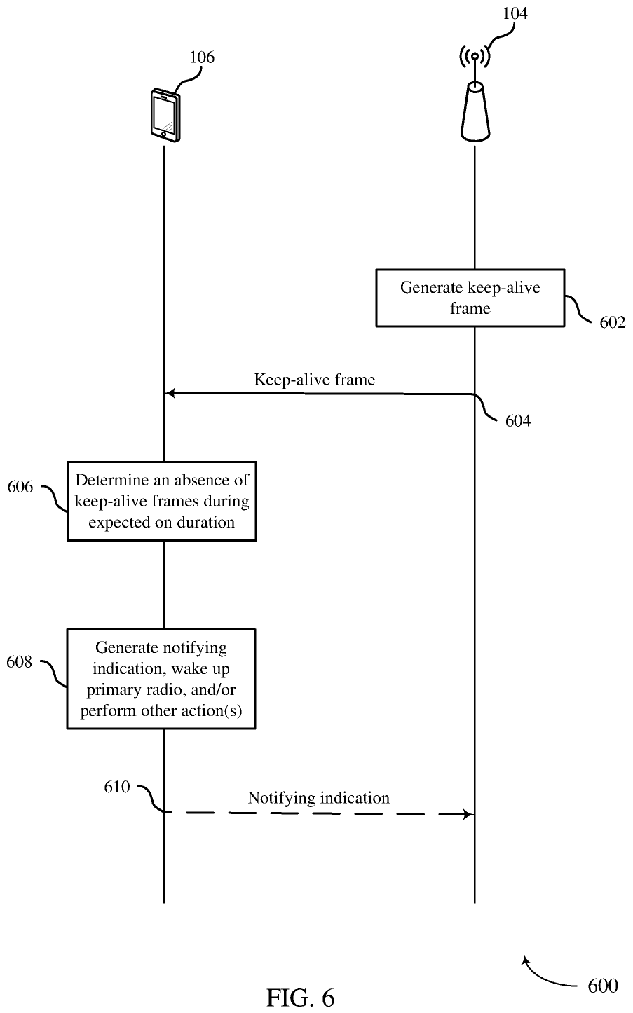

FIG. 6 illustrates an example of a process flow 600 that supports utilization of keep-alive frames in WUR communications in accordance with various aspects of the present disclosure. Process flow 600 may include the STA 106 and the AP 104, which may be examples of the corresponding devices described with reference to FIG. 1. The STA 106 may include the WUR 114. In some aspects, one or more steps of the process flow 600 may be performed in conjunction with or in addition to one or more steps of the process flow 300 in FIG. 3.

At step 602, the AP 104 may generate at least one keep-alive frame. In some aspects, the AP 104 may generate at least one keep-alive frame for each expected on duration of the duty cycle periods associated with the WUR 114 of the STA 106.

At step 604, the AP 104 may transmit the at least one keep-alive frame to the STA 106 while the STA 106 is in the WUR mode. In some aspects, the AP 104 may transmit the at least one keep-alive frame to the WUR 114 of the STA 106 during an expected on duration of a duty cycle period associated with the WUR 114 of the STA 106. In some aspects, the AP 104 may be configured to transmit at least one keep-alive frame during each expected on duration of the duty cycle periods associated with the WUR 114 of the STA 106.

At step 606, the STA 106 may determine an absence of keep-alive frames received by the WUR 114 of the STA 106 during the expected on duration of the duty cycle period associated with the WUR 114 of the STA 106. For example, if the STA 106 determines that no keep-alive frames were received by the WUR 114 during the expected on duration, the STA 106 may determine the absence of keep-alive frames during the expected on duration.

At step 608, the STA 106 may take action in response to the determined absence of keep-alive frames received by the WUR 114 during the expected on duration at step 606. In some aspects, the STA 106 may generate an indication configured to notify the AP 104 of the determined absence of keep-alive frames. In some aspects, the STA 106 may generate a frame including the indication to notify the AP 104. For example, the frame may comprise a WUR frame. The STA 106 may transmit the frame from the WUR 114 while in the WUR mode to verify a connection status between the STA 106 and the AP 104, such as at step 610.

According to some aspects, the STA 106 may wake up the primary radio 112 in response to the determined absence of keep-alive frames. For example, the frame including the indication to notify the AP 104 may be transmitted from the primary radio 112 to verify the connection status between the STA 106 and the AP 104, such as at step 610. Alternatively, or additionally, the primary radio 112 of the STA 106 may be configured to scan for a connection with the AP 104 and/or at least one other AP in response to the determined absence of keep-alive frames. By scanning for APs in response to the determined absence of keep-alive frames, roaming may be easily facilitated for the STA 106, such as when the STA 106 is mobile and moving out of range from the AP 104.

According to some aspects, the STA 106 may be configured to perform other actions in response to the determined absence of keep-alive frames. In some aspects, the STA 106 may be configured to enable a functionality extraneous to the WUR 114 of the STA 106. For example, the STA 106 may be configured to provide a notification that the STA 106 lost connectivity with the AP 104 in response to the determined absence of keep-alive frames. The notification may be provided to a user of the STA 106, such as via a user interface of the STA 106. For instance, the user interface of the STA 106 may provide the notification to the user through a visual (e.g., pop-up window), audio, audio-visual, tactile, or other indicator. Other extraneous functionalities may be performed in response to the determined absence of keep-alive frames.

According to some aspects, the STA 106 may be configured to activate a switch, activate an actuator, and/or deactivate an actuator in response to the determined absence of keep-alive frames. In some aspects, the STA 106 may be configured to initiate these extraneous functionalities by sending a signal to the switch and/or actuator. For example, a processing system associated with the WUR 114 of STA 106 may send a signal to the switch and/or actuator, or to a processing system associated with the switch and/or actuator. In some aspects, the WUR 114 may be deployed as a safety mechanism in an IIoT setting, and the WUR 114 may be configured to send the signal in response to the determined absence of keep-alive frames. For instance, the signal may be an emergency signal to stop machine operation via activation or deactivation of one or more switches and actuators of a machine.

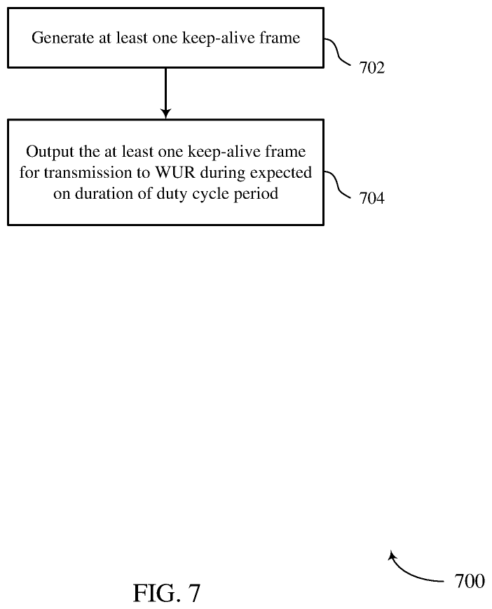

FIG. 7 illustrates a flowchart of an example method 700 that supports utilization of keep-alive frames in WUR communications in accordance with various aspects of the present disclosure. Although the method 700 is described herein with reference to communications among an AP 104 and STAs 106 as discussed above with respect to FIG. 1, a person having ordinary skill in the art will appreciate that the method 700 may be implemented by other suitable devices and systems. Although the method 700 is described herein with reference to a particular order, in various examples, blocks herein may be performed in a different order, or omitted, and additional blocks may be added.

In block 702, the method comprises generating at least one keep-alive frame. In block 704, the method further comprises outputting the at least one keep-alive frame for transmission to a WUR during an expected on duration of a duty cycle period associated with the WUR.

In some examples, an apparatus for wireless communication may perform some of the aspects described herein. In some examples, the apparatus comprises means for generating at least one keep-alive frame. The apparatus further comprises means for outputting the at least one keep-alive frame for transmission to a WUR during an expected on duration of a duty cycle period associated with the WUR.

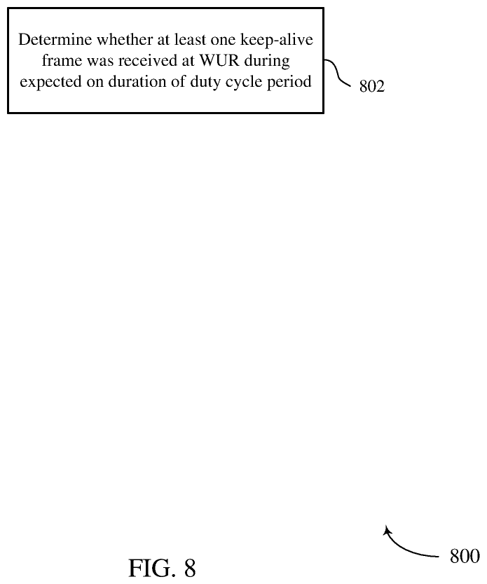

FIG. 8 illustrates a flowchart of an example method 800 that supports utilization of keep-alive frames in WUR communications in accordance with various aspects of the present disclosure. Although the method 800 is described herein with reference to communications among an AP 104 and STAs 106 as discussed above with respect to FIG. 1, a person having ordinary skill in the art will appreciate that the method 800 may be implemented by other suitable devices and systems. Although the method 800 is described herein with reference to a particular order, in various examples, blocks herein may be performed in a different order, or omitted, and additional blocks may be added.

In block 802, the method comprises determining whether at least one keep-alive frame was received at a WUR during an expected on duration of a duty cycle period associated with the WUR.

In some examples, an apparatus for wireless communication may perform some of the aspects described herein. In some examples, the apparatus comprises means for determining whether at least one keep-alive frame was received at a WUR during an expected on duration of a duty cycle period associated with the WUR.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The various operations of methods described above may be performed by any suitable means capable of performing the corresponding functions. The means may include various hardware and/or software component(s) and/or module(s), including, but not limited to a circuit, an application specific integrated circuit (ASIC), or a processor. Generally, where there are operations illustrated in figures, those operations may have corresponding counterpart means-plus-function components with similar numbering.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, the interface to output a frame for transmission and the interface to obtain a frame (which may be referred to as first and second interfaces herein) may be the same interface.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a station 115 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-Ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. In certain aspects, the computer program product may include packaging material.

Further, it should be appreciated that modules and/or other appropriate means for performing the methods and techniques described herein can be downloaded and/or otherwise obtained by a station and/or access point as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a station and/or access point can obtain the various methods upon coupling or providing the storage means to the device. Moreover, any other suitable technique for providing the methods and techniques described herein to a device can be utilized.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein. It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications by a first wireless node that includes a wakeup radio (WUR), the apparatus comprising:
a first interface configured to obtain at least one keep-alive frame; and
a processing system configured to determine the at least one keep-alive frame was received at the WUR during an expected on duration of a duty cycle period associated with the WUR of the first wireless node.

2. The apparatus of claim 1, wherein the processing system is further configured to determine an absence of the at least one keep-alive frame received by the WUR during the expected on duration of the duty cycle period associated with the WUR of the first wireless node.

3. The apparatus of claim 2, wherein the processing system is further configured to wake up a primary radio of the first wireless node in response to the determined absence of the at least one keep-alive frame; and wherein, in response to the determined absence of the at least one keep-alive frame, the primary radio of the first wireless node is configured to: transmit a frame to a second wireless node to verify a connection status between the first wireless node and the second wireless node, scan for a connection with a third wireless node, or a combination thereof.

4. The apparatus of claim 1, wherein the at least one keep-alive frame comprises a WUR beacon frame.

5. The apparatus of claim 4, wherein the WUR beacon frame is individually addressed to the first wireless node.

6. The apparatus of claim 5, wherein the WUR beacon frame is protected, secure, or a combination thereof.

7. The apparatus of claim 4, wherein an ID field of the WUR beacon frame includes a WUR identifier associated with the first wireless node.

8. The apparatus of claim 1, wherein the at least one keep-alive frame comprises a WUR wake-up frame.

9. The apparatus of claim 8, wherein the WUR wake-up frame includes a bit configured to indicate keep-alive functionality of the WUR wake-up frame.

10. The apparatus of claim 9, wherein the bit is further configured to indicate wakeup of a primary radio of the first wireless node.

11. The apparatus of claim 1, wherein the processing system is further configured to generate a first management frame including an indication to request transmission of keep-alive frames from a second wireless node to the first wireless node, and wherein a primary radio of the first wireless node is configured to transmit the first management frame to the second wireless node.

12. The apparatus of claim 11, wherein the indication comprises a bit in a WUR Mode information element.

13. The apparatus of claim 11, wherein the primary radio of the first wireless node is further configured to receive a second management frame from the second wireless node in response to transmission of the first management frame, wherein the second management frame includes an indication for confirming or rejecting the request for transmission of keep-alive frames.

14. The apparatus of claim 1, wherein the processing system is further configured to generate a WUR frame including an indication to request transmission of keep-alive frames from a second wireless node, and wherein the apparatus further includes a second interface configured to output the WUR frame for transmission from the WUR of the first wireless node to the second wireless node.

15. An apparatus for wireless communications by a first wireless node, comprising:
a processing system configured to generate at least one keep-alive frame; and
a first interface configured to output the at least one keep-alive frame for transmission to a wakeup radio (WUR) of a second wireless node during an expected on duration of a duty cycle period associated with the WUR of the second wireless node.

16. The apparatus of claim 15, wherein the processing system is further configured to generate keep-alive frames for each expected on duration associated with the WUR of the second wireless node, and wherein the first interface is further configured to output the keep-alive frames during each expected on duration associated with the WUR of the second wireless node.

17. The apparatus of claim 16, wherein the first interface is configured to output the at least one keep-alive frame to a WUR of a third wireless node during an expected on duration of a duty cycle period associated with the WUR of the third wireless node.

18. The apparatus of claim 15, wherein the at least one keep-alive frame comprises a WUR beacon frame.

19. The apparatus of claim 15, wherein the at least one keep-alive frame comprises a WUR wake-up frame.

20. The apparatus of claim 19, wherein the WUR wake-up frame includes a bit configured to indicate keep-alive functionality of the WUR wake-up frame.

21. The apparatus of claim 15, wherein the processing system is further configured to obtain an indication to generate keep-alive frames for the second wireless node.

22. The apparatus of claim 21, wherein the at least one keep-alive frame is generated in response to the obtained indication.

23. The apparatus of claim 21, wherein the processing system is further configured to generate a first frame including an indication to utilize keep-alive frames in a WUR mode, and wherein the first interface is further configured to output the first frame for transmission to the second wireless node.

24. The apparatus of claim 23, wherein the first frame comprises a management frame for transmission to a primary radio of the second wireless node or a WUR frame for transmission to the WUR of the second wireless node.

25. The apparatus of claim 21, wherein the indication is obtained from a first frame received from the second wireless node, the first frame including an indication to request transmission of keep-alive frames.

26. The apparatus of claim 25, wherein the first frame comprises a management frame received from a primary radio of the second wireless node or a WUR frame received from the WUR of the second wireless node.

27. The apparatus of claim 26, wherein the first frame comprises the management frame, and wherein the indication comprises a bit in a WUR Mode information element.

28. The apparatus of claim 25, wherein the processing system is further configured to generate a management frame in response to the first frame, wherein the management frame includes an indication for confirming or rejecting the request for transmission of keep-alive frames, and wherein the first interface is further configured to output the management frame for transmission to the second wireless node.

29. A wireless node comprising:
a wakeup radio (WUR) configured to obtain at least one keep-alive frame; and
a processing system operatively connected to the WUR, the processing system configured to determine the at least one keep-alive frame was received at the WUR during an expected on duration of a duty cycle period associated with the WUR of the wireless node.

30. A first wireless node, comprising:
a processing system configured to generate at least one keep-alive frame; and
a transmitter configured to transmit the at least one keep-alive frame to a wakeup radio (WUR) of a second wireless node during an expected on duration of a duty cycle period associated with the WUR of the second wireless node.
